(19) United States
(12) Patent Application Publication
(10) Pub. No.: US 2019/0041928 A1
(43) Pub. Date: Feb. 7, 2019

(54) TECHNOLOGIES FOR PREDICTIVE FEED FORWARD MULTIPLE INPUT MULTIPLE OUTPUT SSD THERMAL THROTTLING

(71) Applicant: Intel Corporation, Santa Clara, CA (US)

(72) Inventor: Shirish Bahirat, Longmont, CO (US)

(21) Appl. No.: 16/128,663

(22) Filed: Sep. 12, 2018

(51) Int. Cl. G06F 1/20; G05B 13/02; G06F 11/07

(52) U.S. Cl. CPC G06F 1/206; G05B 13/026; G06F 11/079; G06F 11/076; G06F 11/0727

(57) ABSTRACT

Technologies controlling thermal properties of a data storage device (e.g., a solid state drive) are disclosed. The data storage device includes a memory having memory units in which to store data. The data storage device also includes a controller to manage the thermal usage therein. The controller estimates a state of the data storage device as a function of one or more inputs. The controller predicts, based on the estimated state, a projected thermal usage in one or more of the memory units and controls, based on the prediction, the thermal usage in the memory units. The controller measures an actual state of the data storage device and refines the estimate based on the measured actual state for subsequent control of the thermal usage.

### BACKGROUND

Modern data storage devices may parallelize storage operations across multiple channels. Each channel may be associated with one or more hardware memory units (e.g., hardware dies) that each can be used for a specified operation. For example, a given memory unit in the channel may be used for read access operations and another memory unit in the channel may be used for write access operations. Further, some data storage devices expose internal parallelism to a compute device, such as a host system that executes one or more single tenant or multi-tenant workloads. In such a case, each concurrently executing workload may access the data storage device in parallel in the channels of the data storage device. For instance, a high performance application workload may read and write data at a number of memory units across multiple channels, while an application workload that requires less performance may perform read and write operations on a single channel

As a result, exposing internal parallelism of the data storage device may cause uneven thermal distribution across the device. For example, a high performance application workload operating on a relatively small number of hardware memory units may reach a thermal threshold at each memory unit while a concurrently executing application operating on other memory units may fall well below that threshold. The unevenness can impact reliability of the memory and cause performance issues such as thermal shutdown, operation failure, unnecessary declaration of bad hardware units, firmware assert failure, and failure to deliver on quality-of-service requirements.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of an example computing environment in which a data storage device manages thermal usage using feed forward control;

FIG. 2 is a simplified block diagram of at least one embodiment of a compute device in the computing environment of FIG. 1;

FIG. 3 is a simplified block diagram of at least one embodiment of an example data storage device described relative to FIG. 1;

FIG. 4 is a simplified block diagram of at least one embodiment of an environment that may be established by a data storage controller described relative to FIG. 3;

FIGS. 5A and 5B are simplified flow diagrams of at least one embodiment of controlling thermal usage in the data storage device of FIG. 1 by the data storage controller of FIG. 3; and

FIG. 6 is a simplified flow diagram of a method for managing thermal usage in the data storage device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

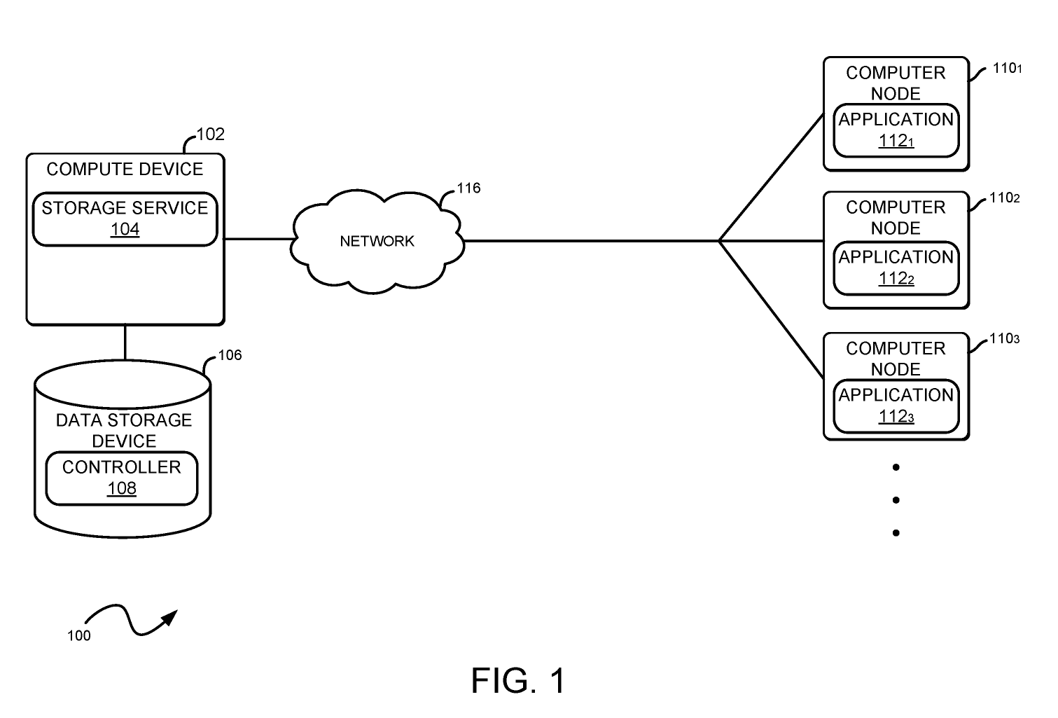

Referring now to FIG. 1, a computing environment 100 in which a data storage device manages thermal usage using feed forward control is illustrated. As shown, the computing environment 100 includes a compute device 102 connected via a network 116 to multiple computer nodes 110₁₋₃. In some embodiments, the computing environment 100 may be indicative of a data center in which multiple workloads (e.g., applications 112₁₋₃) hosted on various computing devices (e.g., computer nodes 110) access storage resources of a host system, such as the compute device 102. In another example embodiment, the computing environment 100 may be indicative of a cloud computing environment in which the physical storage resources are provided in a virtualization setting.

In some embodiments, the compute device 102 includes a storage service 104 and one or more data storage devices (e.g., data storage device 106, which may be a solid state drive (SSD)). The storage service 104 provides a communication interface for the applications 112 in accessing storage resources in the data storage device 106. For example, the applications 112 may send read and write access operation requests to the storage service 104. The storage service 104 may forward the requests to the data storage device 106, which in turn carries out the corresponding operations.

In some embodiments, the data storage device 106 may carry out the requested operations in parallel. For instance, the data storage device 106 may have multiple channels that handle parallelism thereon. As an example, the application 112₁ may execute read operations on a channel A of the data storage device 106 concurrently with write operations executed by the application 112₂ on a channel B of the data storage device 106. Further, the data storage device 106 may expose the channels to the storage service 104 (and other components of the compute device 102). Doing so allows the storage service 104 to manage parallelism for the workloads accessing the data storage device 106.

As further described herein, embodiments disclose techniques for managing thermal usage in the data storage device 106 to prevent uneven thermal distribution therein, e.g., resulting from workloads having heterogeneous performance requirements executing operations in parallel to one another. In some embodiments, the data storage device 106 provides a data storage controller 108 that proactively controls thermal usage based on a state of the data storage device 106 that is estimated for a given time period, given multiple inputs (e.g., a current temperature of the data storage device 106, a number of hardware memory units currently active, temperature and power consumed, and the like. The data storage controller 108 may then refine subsequent estimates used to control thermal usage by providing the error (determined relative to an actual state at the given time period and the estimated state) as an additional input for subsequent estimates of the state.

Advantageously, embodiments provide a multiple input and multiple output feed forward-based mechanism to control thermal usage in the data storage device 106. Such a mechanism has advantages to other approaches to managing thermal usage in the data storage device 106. For example, a proportional-integral-derivative (PID) controller provides a control loop feedback mechanism that significantly adjusts thermal usage in the device as a threshold value is reached. Further, the PID controller introduces hysteresis in a data storage device, which results in degradation of hardware and less reliability in meeting performance, e.g., to comply with a defined quality-of-service. By contrast, the feed forward-based mechanism disclosed herein provides a proactive control technique that controls the thermal usage before the usage even reaches a threshold value, thus minimizing hysteresis and reducing performance loss over an extended period. Further, the feed forward-based mechanism adapts to the state of the data storage device 106 and thus does not require manual tuning. Further still, the techniques described herein may scale to allow independent control of each channel, predefined thermal group, and the like in the data storage device 106.

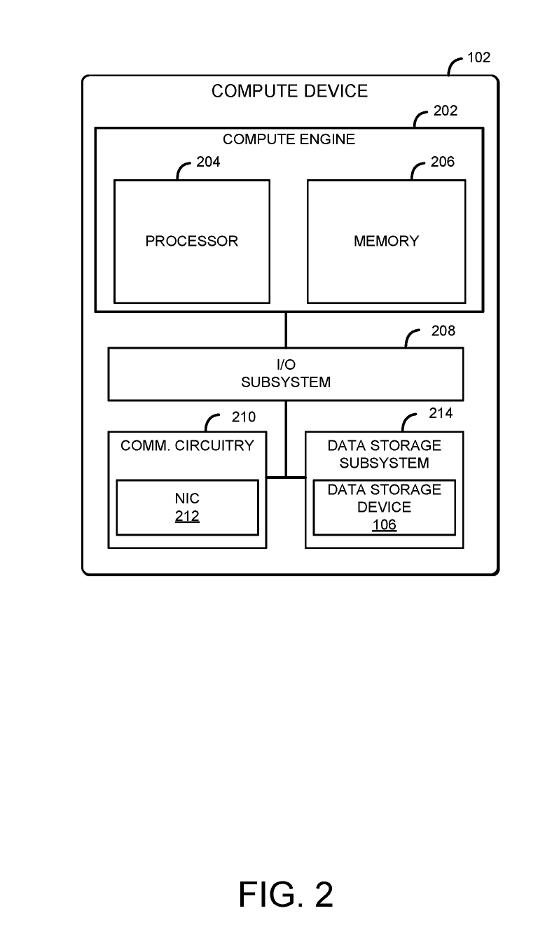

Referring now to FIG. 2, the compute device 102 may be embodied as any type of device capable of performing the functions described herein, providing storage access operations to multiple workloads and managing parallelism in the data storage device 106. As shown, the illustrative compute device 102 includes a compute engine 202, an input/output (I/O) subsystem 208, communication circuitry 210, and a data storage subsystem 214. Of course, in other embodiments, the compute device 102 may include other or additional components, such as those commonly found in a computer (e.g., display, peripheral devices, etc.), such as peripheral devices. Additionally, in some embodiments, one or more of the illustrative components may be incorporated in, or otherwise form a portion of, another component.

The compute engine 202 may be embodied as any type of device or collection of devices capable of performing various compute functions described below. In some embodiments, the compute engine 202 may be embodied as a single device such as an integrated circuit, an embedded system, a field programmable gate array (FPGA), a system-on-a-chip (SOC), or other integrated system or device. Additionally, in some embodiments, the compute engine 202 includes or is embodied as a processor 204 and a memory 206. The processor 204 may be embodied as one or more processors, each processor being a type capable of performing the functions described herein. For example, the processor 204 may be embodied as a single or multi-core processor(s), a microcontroller, or other processor or processing/controlling circuit. In some embodiments, the processor 204 may be embodied as, include, or be coupled to an FPGA, an ASIC, reconfigurable hardware or hardware circuitry, or other specialized hardware to facilitate performance of the functions described herein.

The memory 206 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the memory 206 may be integrated into the processor 204.

The compute engine 202 is communicatively coupled with other components of the computing device 102 via the I/O subsystem 208, which may be embodied as circuitry and/or components to facilitate input/output operations with the compute engine 202 (e.g., with the processor 204 and/or the memory 206) and other components of the compute device 102. For example, the I/O subsystem 208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 208 may form a portion of a system-on-a-chip (SoC) and be incorporated, along with one or more of the processor 204, the memory 206, and other components of the compute device 102, into the compute engine 202.

The communication circuitry 210 may be embodied as any communication circuit, device, or collection thereof, capable of enabling communications over a network between the compute device 102 and other devices (e.g., the computer nodes 110₁₋₃). The communication circuitry 210 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 210 includes a network interface controller (NIC) 212, which may also be referred to as a host fabric interface (HFI). The NIC 212 may be embodied as one or more add-in-boards, daughtercards, controller chips, chipsets, or other devices that may be used by the compute device 102 for network communications with remote devices. For example, the NIC 212 may be embodied as an expansion card coupled to the I/O subsystem 208 over an expansion bus such as PCI Express.

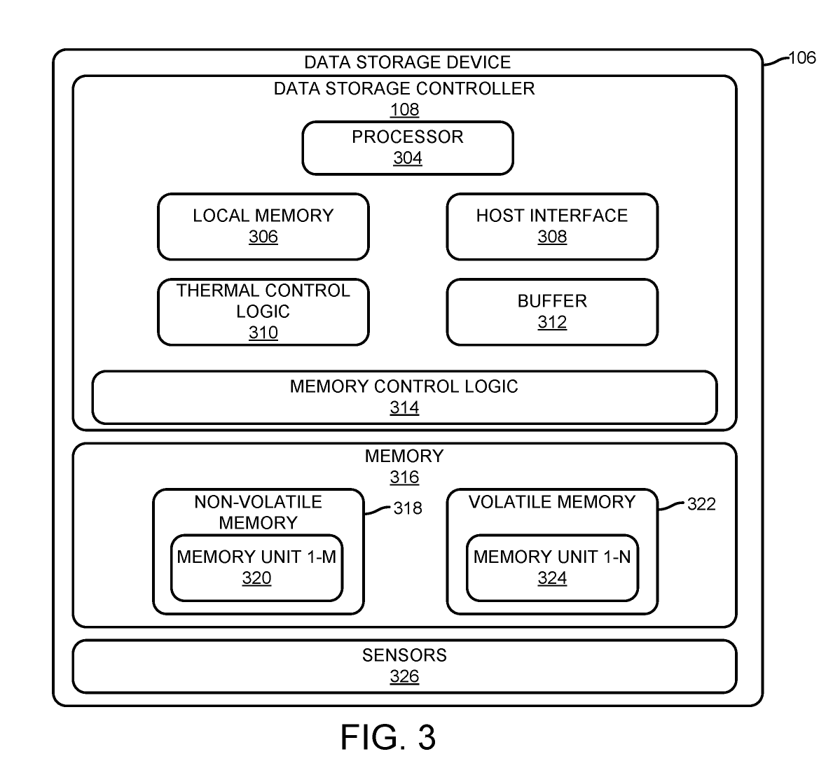

The data storage subsystem 214 may be embodied as any type of devices configured for short-term or long-term storage of data such as the data storage device 106. The data storage device 106 may be embodied as memory devices and circuits, solid state drives (SSDs), memory cards, hard disk drives, or other data storage devices. The illustrative data storage device 106 is embodied as one or more SSDs that expose internal parallelism to components of the compute device 102, allowing the compute device 102 (e.g., via applications such as the storage service 104) to perform storage operations the data storage device 106 in parallel. However, in other embodiments, the data storage device 106 may be embodied as or include any other memory devices capable of managing thermal usage according to the functions disclosed herein. The data storage device 106 is described further relative to FIG. 3.

Additionally or alternatively, the compute device 102 may include one or more peripheral devices. Such peripheral devices may include any type of peripheral device commonly found in a compute device such as a display, speakers, a mouse, a keyboard, and/or other input/output devices, interface devices, and/or other peripheral devices.

Referring now to FIG. 3, in the illustrative embodiment, the data storage device 106 includes the data storage controller 108, a memory 316, which illustratively includes a non-volatile memory 318 and a volatile memory 322, and one or more sensors 326. The data storage controller 108 is generally to estimate a state of the data storage device 106 as a function of one or more inputs (e.g., a current temperature of the data storage device 106, current power usage, number of active memory units, etc.). The data storage controller 108 is also generally to predict, based on the estimated state, a projected thermal usage in memory units of the data storage device 106. The data storage controller 108 is also to control the thermal usage based on the prediction, measure an actual state of the apparatus, and refine the estimate based on the measured state for subsequent control of the thermal usage. The data storage device 106 may be embodied as any type of device capable of storing data and performing the functions described herein. As stated, the data storage device 106 illustrated is embodied as an SSD that exposes internal parallelism of channels to the compute device 102.

The data storage controller 108 may be embodied as any type of control device, circuitry or collection of hardware devices capable of managing thermal usage in the data storage device 106. In the illustrative embodiment, the data storage controller 108 includes a processor (or processing circuitry) 304, a local memory 306, a host interface 308, a thermal control logic 310, a buffer 312, and a memory control logic 314. The memory control logic 314 can be in the same die or integrated circuit as the processor 304 and the memory 306, 316. In some cases, the processor 304, memory control logic 314, and the memory 306, 316 can be implemented in a single die or integrated circuit. Of course, the data storage controller 108 may include additional devices, circuits, and/or components commonly found in a drive controller of an SSD in other embodiments.

The processor 304 may be embodied as any type of processor capable of performing the functions disclosed herein. For example, the processor 304 may be embodied as a single or multi-core processor(s), digital signal processor, microcontroller, or other processor or processing/controlling circuit. Similarly, the local memory 306 may be embodied as any type of volatile and/or non-volatile memory or data storage capable of performing the functions disclosed herein. In the illustrative embodiment, the local memory 306 stores firmware and/or instructions executable by the processor 304 to perform the described functions of the data storage controller 108. In some embodiments, the processor 304 and the local memory 306 may form a portion of a System-on-a-Chip (SoC) and be incorporated, along with other components of the data storage controller 108, onto a single integrated circuit chip.

The processor 204 may be embodied as any type of processor capable of performing the functions described herein. For example, the processor 304 may be embodied as a single or multi-core processor(s), digital signal processor, microcontroller, or other processor or processing/controlling circuit. Similarly, the local memory 306 may be embodied as any type of volatile and/or non-volatile memory or data storage capable of performing the functions described herein. In the illustrative embodiment, the local memory 306 stores firmware and/or other instructions executable by the processor 304 to perform the described functions of the data storage controller 108. In some embodiments, the processor 304 and the local memory 306 may form a portion of a System-on-a-Chip (SoC) and be incorporated, along with other components of the data storage controller 108, onto a single integrated circuit chip.

The host interface 308 may also be embodied as any type of hardware processor, processing circuitry, input/output circuitry, and/or collection of components capable of facilitating communication of the data storage device 106 with a host device or service (e.g., a host application). That is, the host interface 308 embodies or establishes an interface for accessing data stored on the data storage device 106 (e.g., stored in the memory 316). To do so, the host interface 308 may be configured to use any suitable communication protocol and/or technology to facilitate communications with the data storage device 106 depending on the type of data storage device. For example, the host interface 308 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology in some embodiments.

The thermal control logic 310 may be embodied as any device capable of performing operations to manage thermal usage, e.g., by controlling credits applied to hardware memory units (e.g., which are indicative of dies in the data storage device 106). In an embodiment, a credit may be a unit that corresponds to an available or unavailable state of memory units in the data storage device 106. A credit being allocated to a memory unit is indicative of the memory unit being unavailable (e.g., the memory unit is used for storage operations by a given workload). By allocating credits, the data storage controller may control thermal usage (e.g., deactivating a memory unit may reduce thermal usage overall in the data storage device and activating a memory unit may increase thermal usage). As such, the thermal control logic 310 may be embodied as an application specific integrated circuit (ASIC), a field programmable gate array (FPGA), a dedicated microprocessor, or other hardware logic devices/circuitry. In some embodiments, the thermal control logic 310 is incorporated into the processor rather than being a discrete component.

The buffer 312 of the data storage controller 108 is embodied as volatile memory used by data storage controller 108 to temporarily store data that is being read from or written to the memory 316. The particular size of the buffer 312 may be dependent on the total storage size of the memory 316. The memory control logic 314 is illustratively embodied as hardware circuitry and/or device configured to control the read/write access to data at particular storage locations of memory 316.

The non-volatile memory 318 may be embodied as any type of data storage capable of storing data in a persistent manner (even if power is interrupted to non-volatile memory 318). For example, in the illustrative embodiment, the non-volatile memory 318 is embodied as one or more non-volatile memory devices. The non-volatile memory devices of the non-volatile memory 318 are illustratively embodied as quad level cell (QLC) NAND Flash memory. However, in other embodiments, the non-volatile memory 318 may be embodied as any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM.

The volatile memory 322 may be embodied as any type of data storage capable of storing data while power is supplied volatile memory 322. For example, in the illustrative embodiment, the volatile memory 322 is embodied as one or more volatile memory devices, and is periodically referred to hereinafter as volatile memory 322 with the understanding that the volatile memory 322 may be embodied as other types of non-persistent data storage in other embodiments. The volatile memory devices of the volatile memory 322 are illustratively embodied as dynamic random-access memory (DRAM) devices, but may be embodied as other types of volatile memory devices and/or memory technologies capable of storing data while power is supplied to the volatile memory 322.

Each of the non-volatile memory 318 and the volatile memory 322 includes memory units 1-M 320 and 1-N 324, respectively. Each of the memory units 1-M 320 and 1-N 324 may be embodied as hardware units (e.g., dies) used to store data. Further, one or more memory units 1-M 320 and 1-N 324 may be grouped together to form a given channel in the data storage device 106. The sensors 326 may be embodied as any type of hardware or software sensor used to monitor properties of the data storage device 106, such as thermal sensors, power usage sensors, memory unit sensors, and the like. A thermal sensor may monitor temperature and changes therein on the data storage device 106. The power usage sensors may monitor power consumed by the data storage device 106. The memory unit sensors can identify whether a given memory unit is currently available or unavailable (e.g., whether a memory unit is activated to be used by a workload).

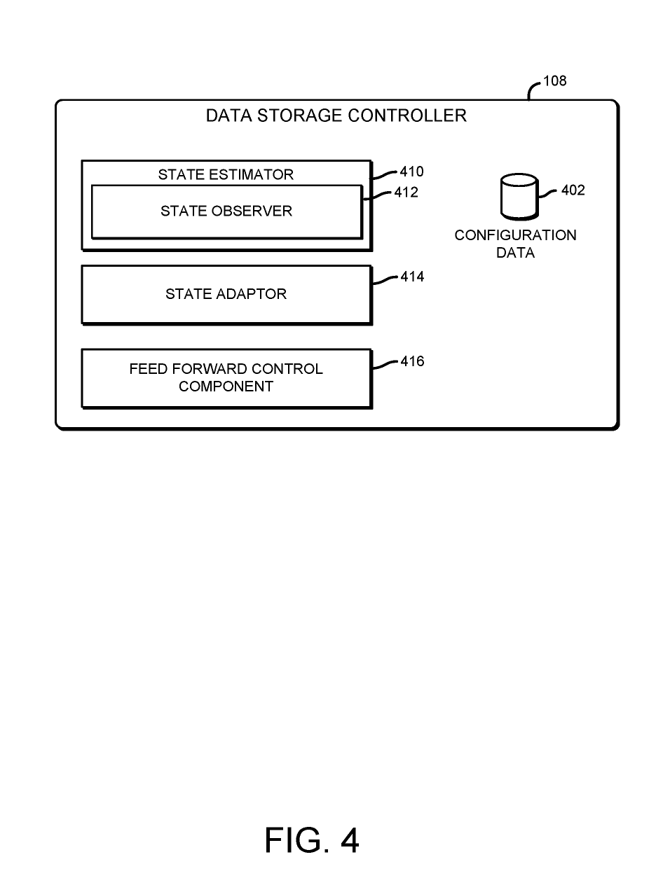

Referring now to FIG. 4, the data storage controller 108 may establish an environment 400 during operation. The illustrative embodiment includes a state estimator 410, a state adaptor 414, and a feed forward control component 416. Each of the components of the environment 400 may be embodied as hardware, firmware, software, or a combination thereof. Further, in some embodiments, one or more of the components of the environment 400 may be embodied as circuitry or a collection of electrical devices (e.g., state estimator circuitry 410, state adaptor circuitry 414, and feed forward control component circuitry 416, etc.). It should be appreciated that, in some embodiments, one or more of the state estimator circuitry 410, state adaptor circuitry 414, and feed forward control component circuitry 416 may form a portion of one or more of the processor 304, the memory control logic 314, the sensors 326, and/or other components of the data storage device 106. In the illustrative embodiment, the environment 400 also includes configuration data 402, which may be embodied as any data indicative of predefined threshold levels for thermal usage, power usage, mappings for workloads to channels and memory units (e.g., the memory units 1-M 320), channel configurations (e.g., which memory units 1-M 320 are associated to a given channel), and the like.

The state estimator 410, which may be embodied as hardware, firmware, software, virtualized hardware, emulated architecture, and/or a combination thereof as discussed above, is to evaluate properties within the data storage device 106 and, based on the evaluation, estimate the state of the data storage device 106 used to predict a thermal usage for a given period of time. The state estimator 410 may do so on a channel level. To do so, the state estimator 410 includes a state observer 412, which receives various inputs, such as a number of active dies (e.g., hardware memory units 1-M 320 and 1-N 324), instantaneous power consumed, temperature of the data storage device 106, and the like at each channel. Given these inputs, the state observer 412 estimates the state of the data storage device 106 or channel. To do so, the state observer 412 may perform various techniques such as a Kalman filter, state space algorithm, least mean squared error correction, and so on.

For example, the state observer 412 may use state space realization using matrices A, B, C, and D, where A is an n x m matrix. x(t) is indicative of the state of the data storage device 106, and L is the n x m matrix for observer gain. States evaluated can include a number of active dies for a thermally managed group (e.g., a channel or multiple channels), sensors available, an expected temperature of the data storage device 106, etc. If there is error between an expected and measured learning gain, then L corrects the estimation. This may be represented in the following equations:

ŷ(t)=C\hat{x}(t)+Du(t)

x(t)=Ax(t)+Bu(t)+L[y(t)−y(t)]

The state adaptor 414, which may be embodied as hardware, firmware, software, virtualized hardware, emulated architecture, and/or a combination thereof, is to allocate/deallocate credits to dies (e.g., memory units) and apply control to the allocated credits, allowing for control of multiple thermal groups within the data storage device 106. For example, the state adaptor 414 does so using y(t). Each index in vector y(t) may correspond to a given thermally managed group. Under this approach, the state adaptor 414 controls the credits to maintain a specified temperature, rather than drive error values to low. The state adaptor 414 may also determine die temperature (e.g., temperature of one or more memory units) as a function of applied power. The state adaptor 414 may measure an actual state of the data storage device 106 in a given period of time (e.g., from the die temperatures) and measure error indicative of a deviation between the estimated state and the actual state for that period of time.

The feed forward control component 416, which may be embodied as hardware, firmware, software, virtualized hardware, emulated architecture, and/or a combination thereof, is to transmit the error measure to the state estimator 410, which, in turn, uses the error measure for a subsequent estimate in the state of the data storage device 106. It should be appreciated that each of the state estimator 410, state adaptor 414, and feed forward control component 416 may be separately embodied as hardware, firmware, software, virtualized hardware, emulated architecture, and/or a combination thereof. For example, the feed forward control component 416 may be embodied as a hardware component, while the state estimator 410 and state adaptor 414 are embodied as virtualized hardware components or as some other combination of hardware, firmware, software, virtualized hardware, emulated architecture, and/or a combination thereof.

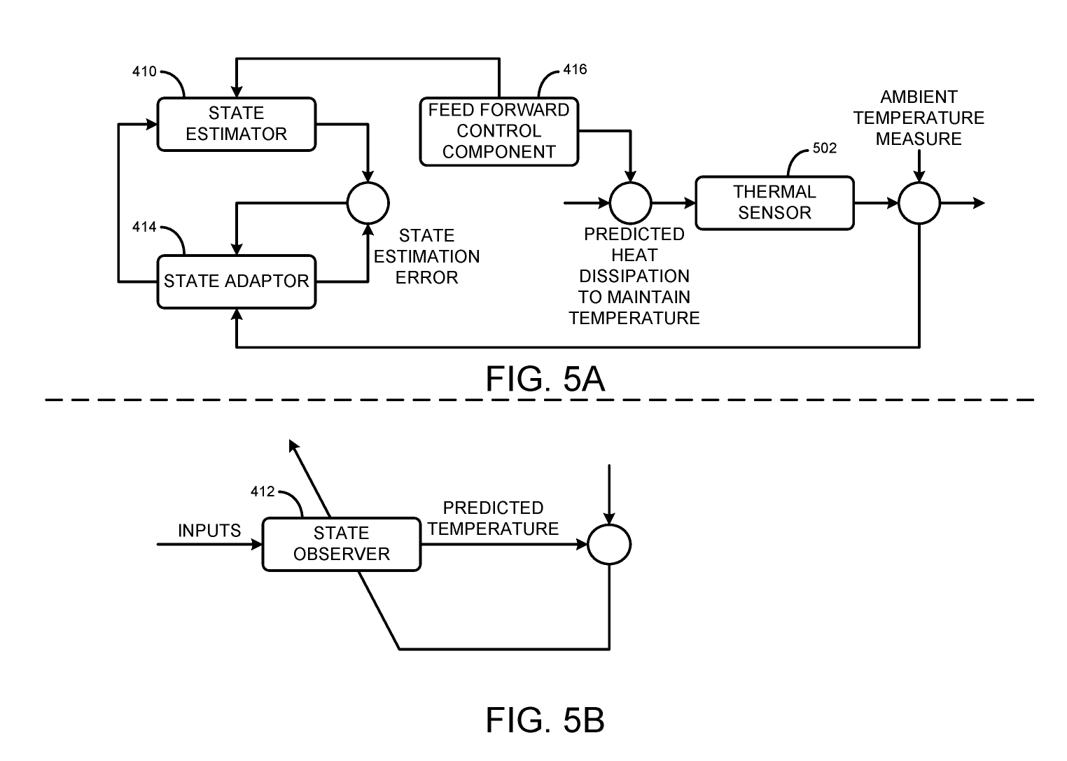

Referring now to FIGS. 5A and 5B, diagrams further describing interaction between the components of the environment 400 are shown. FIG. 5A displays the components interacting in a feed forward control loop. The state estimator 410 may estimate the state of the data storage device 106 at each channel based on a number of inputs, such as inputs sent from the state adaptor 414 and the feed forward control component 416. The state estimator 410 may feed the estimated state to the state adaptor 414, which in turn controls credits to manage temperature in the data storage device 106. The state estimator 410 adapts to different ambient conditions and workloads. The state estimator 410 computes the projected temperature as a function of allocated credits and inputs (e.g., ambient temperature measures and device temperature data obtained by a thermal sensor 502) and controls the credits before the temperature exceeds a given threshold. Referring to FIG. 5B, the state observer 412 receives multiple inputs as described above and may predict the temperature for the given estimated state. The state observer 412 outputs this predicted temperature for retrieval by the state adaptor 414. The feed forward control component 416 may also predict heat dissipation to maintain temperature.

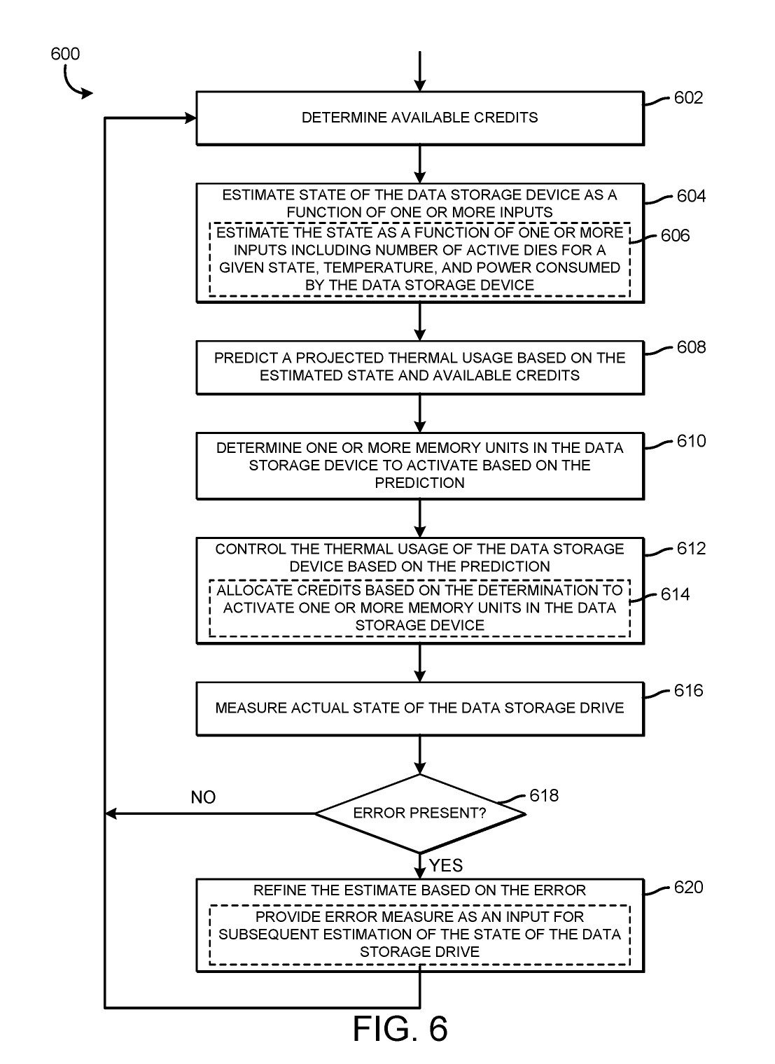

Referring now to FIG. 6, the data storage device 106, in operation, performs a method 600 for managing thermal usage therein. The method 600 may be carried out by the data storage controller 108 or other components within the data storage device 106. As shown, the method 600 begins in block 602, in which the data storage controller 108 determines available credits corresponding to unused memory units in the data storage device 106.

In block 604, the data storage controller 108 estimates a state of the data storage device 106 as a function of one or more inputs. As noted, the estimated state may be used to control credits to manage temperature in the data storage device 106. More particularly, in block 606, the data storage device 106 estimates the state as a function of inputs such as a number of dies in a given state (e.g., whether active or inactive), temperature of the data storage device 106 or channels, temperature of dies, power consumer by the data storage device, and the like.

In block 608, the data storage controller 108 predicts a projected thermal usage in the data storage device 106 and in each channel based on the estimated state and on the available credits. In block 610, the data storage controller 108 determines one or more dies (e.g., memory units) in the data storage device 106 to activate based on the prediction using the techniques previously described herein. In block 612, the data storage controller 108 controls the thermal usage of the data storage device 106 (e.g., by channel) based on the prediction. For instance, to do so, in block 614, the data storage controller 108 allocates credits based on the determination to selectively activate or deactivate one or more memory units in the data storage device 106.

In block 616, the data storage controller 108 measures the actual state of the data storage device 106 (e.g., by channel). In block 618, the data storage controller 108 determines, based on the actual state of the data storage device 106 and on the previously estimated state, whether any error is present in the estimate (e.g., a deviation from values in properties of the estimated state and the measured actual state). If error is not present, then the method 600 loops back to block 602 to determine available credits. Otherwise, if error is present, then the data storage controller 108 refines subsequent estimates based on the error. In particular, in block 620, the data storage controller 108 provides the error measure as one of the inputs provided in subsequently estimating the state of the data storage device 106. Thereafter, the data storage controller 108 may factor in the error measure as a variable in predicting a thermal usage in the data storage device 106.

### EXAMPLES

Illustrative examples of the technologies disclosed herein are provided below. An embodiment of the technologies may include any one or more, and any combination of, the examples described below.

Example 1 includes an apparatus comprising a memory having a plurality memory units in which to store data; and a controller to manage thermal usage in the apparatus, wherein the controller is further to estimate a state of the apparatus as a function of one or more inputs; predict, based on the estimated state, a projected thermal usage in one or more of the plurality of memory units; control, based on the prediction, the thermal usage in the one or more of the plurality of memory units; measure an actual state of the apparatus; and refine the estimate based on the measured actual state for subsequent control of the thermal usage.

Example 2 includes the subject matter of Example 1, and wherein the controller is further to determine an error measure indicative of a deviation of the estimated state from the measured actual state of the apparatus.

Example 3 includes the subject matter of any of Examples 1 and 2, and wherein to refine the estimate based on the measured actual state for subsequent control of the thermal usage comprises to provide the error measure as an additional input in a subsequent estimate of the state of the apparatus.

Example 4 includes the subject matter of any of Examples 1-3, and wherein to estimate the state of the apparatus comprises to estimate the state as a function of one or more of a number of active memory units for a given state, a current temperature of the apparatus, and a measure of power consumed by the apparatus.

Example 5 includes the subject matter of any of Examples 1-4, and wherein the controller is further to determine an amount of credits indicative of available memory units of the plurality of memory units in the apparatus, wherein to predict the projected thermal usage is further based on the determined amount of credits.

Example 6 includes the subject matter of any of Examples 1-5, and wherein the controller is further to identify which of the available memory units to activate for storage of the data based on the prediction.

Example 7 includes the subject matter of any of Examples 1-6, and wherein to control the temperature in the one or more of the plurality of memory units comprises to allocate one or more of the credits based on the identified available memory units.

Example 8 includes the subject matter of any of Examples 1-7, and wherein to predict a projected thermal usage in the one or more of the plurality of memory units based on the estimated state comprises to predict the projected thermal usage in one or more channels of the apparatus, wherein each channel includes one or more of the plurality of memory units.

Example 9 includes a compute device comprising a data storage device having a memory including a plurality memory units in which to store data and a controller to manage thermal usage in the data storage device, wherein the controller is further to estimate a state of the data storage device as a function of one or more inputs; predict, based on the estimated state, a projected thermal usage in one or more of the plurality of memory units; control, based on the prediction, the thermal usage in the one or more of the plurality of memory units; measure an actual state of the data storage device; and refine the estimate based on the measured actual state for subsequent control of the thermal usage.

Example 10 includes the subject matter of Example 9, and wherein the controller is further to determine an error measure indicative of a deviation of the estimated state from the measured actual state of the data storage device.

Example 11 includes the subject matter of any of Examples 9 and 10, and wherein to refine the estimate based on the measured actual state for subsequent control of the thermal usage comprises to provide the error measure as an additional input in a subsequent estimate of the state of the data storage device.

Example 12 includes the subject matter of any of Examples 9-11, and wherein to estimate the state of the data storage device comprises to estimate the state as a function of one or more of a number of active memory units for a given state, a current temperature of the data storage device, and a measure of power consumed by the data storage device.

Example 13 includes the subject matter of any of Examples 9-12, and wherein the controller is further to determine an amount of credits indicative of available memory units of the plurality of memory units in the apparatus, wherein to predict the projected thermal usage is further based on the determined amount of credits.

Example 14 includes the subject matter of any of Examples 9-13, and wherein the controller is further to identify which of the available memory units to activate for storage of the data based on the prediction.

Example 15 includes the subject matter of any of Examples 9-14, and wherein to control the temperature in the one or more of the plurality of memory units comprises to allocate one or more of the credits based on the identified available memory units.

Example 16 includes the subject matter of any of Examples 9-15, and wherein to predict a projected thermal usage in the one or more of the plurality of memory units based on the estimated state comprises to predict the projected thermal usage in one or more channels of the data storage device, wherein each channel includes one or more of the plurality of memory units.

Example 17 includes a data storage device comprising a memory having a plurality of memory units in which to store data; means for estimating a state of the data storage device as a function of one or more inputs; means for predicting, based on the estimated state, a projected thermal usage in one or more of the plurality of memory units; means for controlling, based on the prediction, the thermal usage in the one or more of the plurality of memory units; circuitry for measuring an actual state of the data storage device; and means for refining the estimate based on the measured actual state for subsequent control of the thermal usage.

Example 18 includes the subject matter of Example 17, and further including circuitry for determining an error measure indicative of a deviation of the estimated state from the measured actual state of the data storage device.

Example 19 includes the subject matter of any of Examples 17 and 18, and wherein the means for refining the estimate based on the measured actual state for subsequent control of the thermal usage comprises circuitry for providing the error measure as an additional input in a subsequent estimate of the state of the data storage device.

Example 20 includes the subject matter of any of Examples 17-19, and wherein the means for predicting a projected thermal usage in the one or more of the plurality of memory units based on the estimated state comprises means for predicting the projected thermal usage in one or more channels of the data storage device, each channel including one or more of the plurality of memory units.

1. An apparatus comprising:
a memory having a plurality memory units in which to store data; and
a controller to manage thermal usage in the apparatus, wherein the controller is further to:
estimate a state of the apparatus as a function of one or more inputs;
predict, based on the estimated state, a projected thermal usage in one or more of the plurality of memory units;
control, based on the prediction, the thermal usage in the one or more of the plurality of memory units;
measure an actual state of the apparatus; and
refine the estimate based on the measured actual state for subsequent control of the thermal usage.

2. The apparatus of claim 1, wherein the controller is further to:
determine an error measure indicative of a deviation of the estimated state from the measured actual state of the apparatus.

3. The apparatus of claim 2, wherein to refine the estimate based on the measured actual state for subsequent control of the thermal usage comprises to provide the error measure as an additional input in a subsequent estimate of the state of the apparatus.

4. The apparatus of claim 1, wherein to estimate the state of the apparatus comprises to:
estimate the state as a function of one or more of a number of active memory units for a given state, a current temperature of the apparatus, and a measure of power consumed by the apparatus.

5. The apparatus of claim 1, wherein the controller is further to determine an amount of credits indicative of available memory units of the plurality of memory units in the apparatus, wherein to predict the projected thermal usage is further based on the determined amount of credits.

6. The apparatus of claim 5, wherein the controller is further to identify which of the available memory units to activate for storage of the data based on the prediction.

7. The apparatus of claim 6, wherein to control the temperature in the one or more of the plurality of memory units comprises to allocate one or more of the credits based on the identified available memory units.

8. The apparatus of claim 1, wherein to predict a projected thermal usage in the one or more of the plurality of memory units based on the estimated state comprises to predict the projected thermal usage in one or more channels of the apparatus, wherein each channel includes one or more of the plurality of memory units.

9. A compute device comprising:
a data storage device having a memory including a plurality memory units in which to store data and a controller to manage thermal usage in the data storage device, wherein the controller is further to:
estimate a state of the data storage device as a function of one or more inputs;
predict, based on the estimated state, a projected thermal usage in one or more of the plurality of memory units;
control, based on the prediction, the thermal usage in the one or more of the plurality of memory units;
measure an actual state of the data storage device; and
refine the estimate based on the measured actual state for subsequent control of the thermal usage.

10. The compute device of claim 9, wherein the controller is further to:
determine an error measure indicative of a deviation of the estimated state from the measured actual state of the data storage device.

11. The compute device of claim 10, wherein to refine the estimate based on the measured actual state for subsequent control of the thermal usage comprises to provide the error measure as an additional input in a subsequent estimate of the state of the data storage device.

12. The compute device of claim 9, wherein to estimate the state of the data storage device comprises to:
estimate the state as a function of one or more of a number of active memory units for a given state, a current temperature of the data storage device, and a measure of power consumed by the data storage device.

13. The compute device of claim 9, wherein the controller is further to determine an amount of credits indicative of available memory units of the plurality of memory units in the apparatus, wherein to predict the projected thermal usage is further based on the determined amount of credits.

14. The compute device of claim 13, wherein the controller is further to identify which of the available memory units to activate for storage of the data based on the prediction.

15. The compute device of claim 14, wherein to control the temperature in the one or more of the plurality of memory units comprises to allocate one or more of the credits based on the identified available memory units.

16. The compute device of claim 9, wherein to predict a projected thermal usage in the one or more of the plurality of memory units based on the estimated state comprises to predict the projected thermal usage in one or more channels of the data storage device, wherein each channel includes one or more of the plurality of memory units.

17. A data storage device comprising:
a memory having a plurality of memory units in which to store data;
means for estimating a state of the data storage device as a function of one or more inputs;
means for predicting, based on the estimated state, a projected thermal usage in one or more of the plurality of memory units;
means for controlling, based on the prediction, the thermal usage in the one or more of the plurality of memory units;
circuitry for measuring an actual state of the data storage device; and
means for refining the estimate based on the measured actual state for subsequent control of the thermal usage.

18. The data storage device of claim 17, further comprising circuitry for determining an error measure indicative of a deviation of the estimated state from the measured actual state of the data storage device.

19. The data storage device of claim 18, wherein the means for refining the estimate based on the measured actual state for subsequent control of the thermal usage comprises circuitry for providing the error measure as an additional input in a subsequent estimate of the state of the data storage device.

20. The data storage device of claim 17, wherein the means for predicting a projected thermal usage in the one or more of the plurality of memory units based on the estimated state comprises means for predicting the projected thermal usage in one or more channels of the data storage device, each channel including one or more of the plurality of memory units.
